(19) United States
(12) Patent Application Publication
(10) Pub. No.: US 2026/0237900 A1
(43) Pub. Date: Aug. 13, 2026

(54) ANTENNA STRUCTURE

(71) Applicant: Quanta Computer Inc., Taoyuan City (TW)

(72) Inventors: Chih-Tsung TSENG, Taoyuan City (TW); Chung-Ting HUNG, Taoyuan City (TW); Chun-Yuan WANG, Taoyuan City (TW); Yi-Chih LO, Taoyuan City (TW); Jing-Yao XU, Taoyuan City (TW)

(21) Appl. No.: 19/092,287

(22) Filed: Mar. 27, 2025

(30) Foreign Application Priority Data
Feb. 8, 2025 (TW) 114201329

(51) Int. Cl. H01Q 5/371; H01Q 5/22

(52) U.S. Cl. CPC H01Q 5/371; H01Q 5/22

(57) ABSTRACT

An antenna structure includes a first radiation element, a second radiation element, a third radiation element, a fourth radiation element, a fifth radiation element, a sixth radiation element, a seventh radiation element, an eighth radiation element, and a ninth radiation element. The first radiation element has a feeding point. The second radiation element is coupled to the first radiation element. The third radiation element is coupled to the first radiation element. The fourth radiation element is coupled to a ground voltage. The fourth radiation element is adjacent to the first radiation element. The fifth radiation element is coupled to the ground voltage. The fifth radiation element is adjacent to the first radiation element. The sixth radiation element is coupled to the third radiation element. The sixth radiation element is adjacent to the fourth radiation element. The seventh radiation element is coupled to the fourth radiation element.

### CROSS REFERENCE TO RELATED APPLICATIONS

This application claims priority of Taiwan Patent Application No. 114201329 filed on Feb. 8, 2025, the entirety of which is incorporated by reference herein.

### BACKGROUND OF THE INVENTION

### Field of the Invention

The disclosure generally relates to an antenna structure, and more particularly, it relates to a wideband antenna structure.

### Description of the Related Art

With the advancements being made in mobile communication technology, mobile devices such as portable computers, mobile phones, multimedia players, and other hybrid functional portable electronic devices have become more common. To satisfy consumer demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi systems and using frequency bands of 2.4 GHz, 5.2 GHz, and 5.8 GHz.

Antennas are indispensable elements for wireless communication. If an antenna for signal reception and transmission has an insufficient operational bandwidth, it may degrade the communication quality of the mobile device. Accordingly, it has become a critical challenge for designers to design a small-size, wideband antenna structure.

### BRIEF SUMMARY OF THE INVENTION

In an exemplary embodiment, the invention is directed to an antenna structure that includes a first radiation element, a second radiation element, a third radiation element, a fourth radiation element, a fifth radiation element, a sixth radiation element, a seventh radiation element, an eighth radiation element, a ninth radiation element, and a carrier element. The first radiation element has a feeding point. The second radiation element is coupled to the first radiation element. The third radiation element is coupled to the first radiation element. The fourth radiation element is coupled to a ground voltage. The fourth radiation element is adjacent to the first radiation element. The fifth radiation element is coupled to the ground voltage. The fifth radiation element is adjacent to the first radiation element. The sixth radiation element is coupled to a first connection point on the third radiation element. The sixth radiation element is adjacent to the fourth radiation element. The seventh radiation element is coupled to a second connection point on the fourth radiation element. The eighth radiation element is coupled to a third connection point on the fourth radiation element. The ninth radiation element is coupled to a fourth connection point on the fourth radiation element. The first radiation element, the second radiation element, the third radiation element, the fourth radiation element, the fifth radiation element, the sixth radiation element, the seventh radiation element, the eighth radiation element, and the ninth radiation element are all disposed on the carrier element.

In some embodiments, the fourth radiation element substantially has a meandering shape.

In some embodiments, the combination of the third radiation element and the sixth radiation element substantially has an inverted T-shape.

In some embodiments, the seventh radiation element includes a first portion and a second portion, and an obtuse angle is formed between the first portion and the second portion.

In some embodiments, the eighth radiation element includes a terminal widening portion.

In some embodiments, the antenna structure covers a first frequency band, a second frequency band, and a third frequency band. The first frequency band is from 699 MHz to 960 MHz. The second frequency band is from 1710 MHz to 2170 MHz. The third frequency band is from 2500 MHz to 2690 MHz.

In some embodiments, the total length of the first radiation element and the second radiation element is substantially equal to 0.25 wavelength of the first frequency band.

In some embodiments, the total length of the first radiation element and the third radiation element is substantially equal to 0.25 wavelength of the second frequency band.

In some embodiments, the length of the fourth radiation element is substantially equal to 0.25 wavelength of the first frequency band.

In some embodiments, the length of the fifth radiation element is substantially equal to 0.25 wavelength of the third frequency band.

### BRIEF DESCRIPTION OF DRAWINGS

The invention can be more fully understood by reading the subsequent detailed description and examples with references made to the accompanying drawings, wherein:

FIG. 1 is a diagram of an antenna structure according to an embodiment of the invention; and

FIG. 2 is a diagram of VSWR (Voltage Standing Wave Ratio) of an antenna structure according to an embodiment of the invention.

### DETAILED DESCRIPTION OF THE INVENTION

In order to illustrate the purposes, features and advantages of the invention, the embodiments and figures of the invention are shown in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to...”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

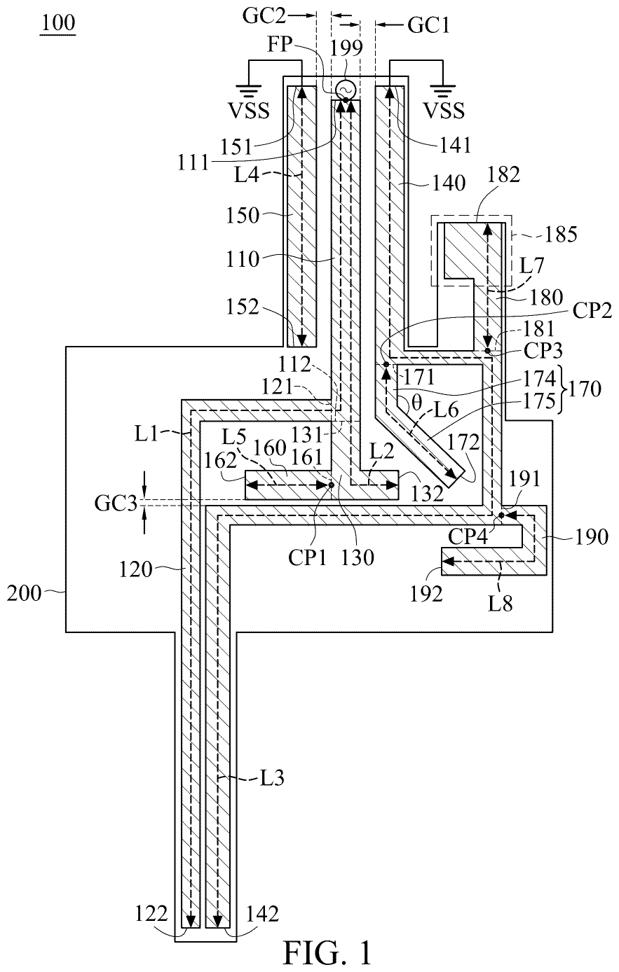

FIG. 1 is a diagram of an antenna structure 100 according to an embodiment of the invention. The antenna structure 100 may be applied to a mobile device, such as a smart phone, a tablet computer, a notebook computer, a wireless access point, a router, or any device with a communication function. Alternatively, the antenna structure 100 may be applied to an electronic device, such as any unit of IOT (Internet of Things).

In the embodiment of FIG. 1, the antenna structure 100 includes a first radiation element 110, a second radiation element 120, a third radiation element 130, a fourth radiation element 140, a fifth radiation element 150, a sixth radiation element 160, a seventh radiation element 170, an eighth radiation element 180, a ninth radiation element 190, and a carrier element 200. The first radiation element 110, the second radiation element 120, the third radiation element 130, the fourth radiation element 140, the fifth radiation element 150, the sixth radiation element 160, the seventh radiation element 170, the eighth radiation element 180, and the ninth radiation element 190 may all be made of metal materials, such as copper, silver, aluminum, iron, or their alloys.

The first radiation element 110 may substantially have a relatively long straight-line shape. Specifically, the first radiation element 110 has a first end 111 and a second end 112. A feeding point FP is substantially positioned at the first end 111 of the first radiation element 110. The feeding point FP may be further coupled to a signal source 199. For example, the signal source 199 may be an RF (Radio Frequency) module for exciting the antenna structure 100.

The second radiation element 120 may substantially have a relatively long L-shape. Specifically, the second radiation element 120 has a first end 121 and a second end 122. The first end 121 of the second radiation element 120 is coupled to the second end 112 of the first radiation element 110. The second end 122 of the second radiation element 120 is an open end.

The third radiation element 130 may substantially have a relatively short L-shape (compared with the second radiation element 120). Specifically, the third radiation element 130 has a first end 131 and a second end 132. The first end 131 of the third radiation element 130 is coupled to the second end 112 of the first radiation element 110. The second end 132 of the third radiation element 130 is an open end.

The fourth radiation element 140 may substantially have a meandering shape. Specifically, the fourth radiation element 140 has a first end 141 and a second end 142. The first end 141 of the fourth radiation element 140 is coupled to a ground voltage VSS. The second end 142 of the fourth radiation element 140 is an open end. For example, the ground voltage VSS may be provided by a system ground plane (not shown) of the antenna structure 100. In some embodiments, the fourth radiation element 140 is adjacent to the first radiation element 110. A first coupling gap GC1 may be formed between the first radiation element 110 and the fourth radiation element 140. In some embodiments, the second end 122 of the second radiation element 120 and the second end 142 of the fourth radiation element 140 are adjacent to each other and are aligned with each other. It should be noted that the term “adjacent” or “close” over the disclosure means that the distance (spacing) between two corresponding elements is smaller than a predetermined distance (e.g., 10 mm or the shorter), but often does not mean that the two corresponding elements directly touch each other (i.e., the aforementioned distance/spacing between them is reduced to 0).

The fifth radiation element 150 may substantially have a relatively median straight-line shape (compared with the first radiation element 110), which may be substantially parallel to the first radiation element 110. Specifically, the fifth radiation element 150 has a first end 151 and a second end 152. The first end 151 of the fifth radiation element 150 is coupled to the ground voltage VSS. The second end 152 of the fifth radiation element 150 is an open end. For example, the second end 122 of the second radiation element 120, the second end 142 of the fourth radiation element 140, and the second end 152 of the fifth radiation element 150 may substantially extend in the same direction. In some embodiments, the fifth radiation element 150 is adjacent to the first radiation element 110. A second coupling gap GC2 may be formed between the first radiation element 110 and the fifth radiation element 150. In some embodiments, the first radiation element 110 is disposed between the fourth radiation element 140 and the fifth radiation element 150.

The sixth radiation element 160 may substantially have a relatively short straight-line shape (compared with the fifth radiation element 150). Specifically, the sixth radiation element 160 has a first end 161 and a second end 162. The first end 161 of the sixth radiation element 160 is coupled to a first connection point CP1 on the third radiation element 130. The second end 162 of the sixth radiation element 160 is an open end. For example, the second end 132 of the third radiation element 130 and the second end 162 of the sixth radiation element 160 may substantially extend in opposite directions. In some embodiments, the combination of the third radiation element 130 and the sixth radiation element 160 substantially has an inverted T-shape. In some embodiments, the sixth radiation element 160 is adjacent to the fourth radiation element 140. A third coupling gap GC3 may be formed between the fourth radiation element 140 and the sixth radiation element 160.

The seventh radiation element 170 may substantially have a bending shape. Specifically, the seventh radiation element 170 has a first end 171 and a second end 172. The first end 171 of the seventh radiation element 170 is coupled to a second connection point CP2 on the fourth radiation element 140. The second end 172 of the seventh radiation element 170 is an open end. In some embodiments, the seventh radiation element 170 includes a first portion 174 and a second portion 175 which are coupled to each other. For example, an obtuse angle θ may be formed between the first portion 174 and the second portion 175 of the seventh radiation element 170. In some embodiments, the seventh radiation element 170 is substantially surrounded by the first radiation element 110, the third radiation element 130, and the fourth radiation element 140.

The eighth radiation element 180 may substantially have a variable-width straight-line shape. Specifically, the eighth radiation element 180 has a first end 181 and a second end 182. The first end 181 of the eighth radiation element 180 is coupled to a third connection point CP3 on the fourth radiation element 140. The second end 182 of the eighth radiation element 180 is an open end. In some embodiments, the eighth radiation element 180 also includes a terminal widening portion 185 positioned at its second end 182.

The ninth radiation element 190 may substantially have an inverted U-shape. Specifically, the ninth radiation element 190 has a first end 191 and a second end 192. The first end 191 of the ninth radiation element 190 is coupled to a fourth connection point CP4 on the fourth radiation element 140. The second end 192 of the ninth radiation element 190 is an open end. For example, the second end 162 of the sixth radiation element 160 and the second end 192 of the ninth radiation element 190 may substantially extend in the same direction.

The first radiation element 110, the second radiation element 120, the third radiation element 130, the fourth radiation element 140, the fifth radiation element 150, the sixth radiation element 160, the seventh radiation element 170, the eighth radiation element 180, and the ninth radiation element 190 may all be disposed on the same surface of the carrier element 200. The shape and type of the carrier element 200 are not limited in the invention. For example, the carrier element 200 may be an FR4 (Flame Retardant 4) substrate, a PCB (Printed Circuit Board), or an FPC (Flexible Printed Circuit). In some embodiments, the antenna structure 100 is a planar antenna structure. However, the invention is not limited thereto. In alternative embodiments, the antenna structure 100 is modified to a 3D (Three-Dimensional) antenna structure, without affecting its radiation performance.

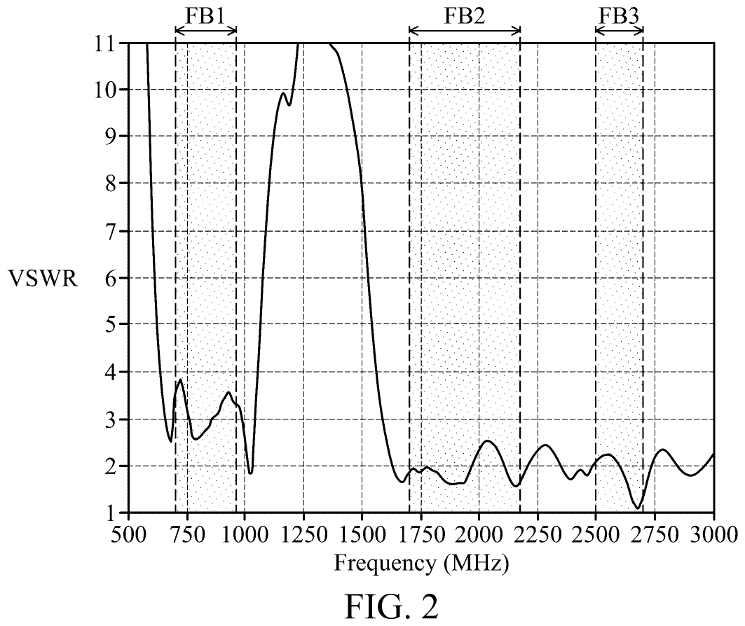

FIG. 2 is a diagram of VSWR (Voltage Standing Wave Ratio) of the antenna structure 100 according to an embodiment of the invention. The horizontal axis represents the operational frequency (MHz), and the vertical axis represents the VSWR. According to the measurement of FIG. 2, the antenna structure 100 can cover a first frequency band FB1, a second frequency band FB2, and a third frequency band FB3. For example, the first frequency band FB1 may be from 699 MHz to 960 MHz, the second frequency band FB2 may be from 1710 MHz to 2170 MHz, and the third frequency band FB3 may be from 2500 MHz to 2690 MHz. Therefore, the antenna structure 100 can support at least the wideband operations of LTE (Long Term Evolution).

In some embodiments, the operational principles of the antenna structure 100 are as follows. The first radiation element 110 and the second radiation element 120 can be excited to generate the first frequency band FB1. The first radiation element 110 and the third radiation element 130 can be excited to generate the second frequency band FB2. The fourth radiation element 140 can be excited by the first radiation element 110 using a coupling mechanism, so as to increase the bandwidth of the first frequency band FB1. The fifth radiation element 150 can be excited by the first radiation element 110 using another coupling mechanism, so as to generate the third frequency band FB3. The sixth radiation element 160 can be configured to fine-tune the impedance matching of the second frequency band FB2. In addition, the seventh radiation element 170, the eighth radiation element 180, and the ninth radiation element 190 can be configured to fine-tune the impedance matching of the first frequency band FB1. According to practical measurements, the proposed antenna structure 100 of the invention can almost prevent its radiation performance from being negatively affected by surrounding metal elements (not shown).

In some embodiments, the element sizes of the antenna structure 100 are as follows. The total length L1 of the first radiation element 110 and the second radiation element 120 may be substantially equal to 0.25 wavelength (λ/4) of the first frequency band FB1 of the antenna structure 100. The total length L2 of the first radiation element 110 and the third radiation element 130 may be substantially equal to 0.25 wavelength (λ/4) of the second frequency band FB2 of the antenna structure 100. The length L3 of the fourth radiation element 140 may be substantially equal to 0.25 wavelength (λ/4) of the first frequency band FB1 of the antenna structure 100. The length L4 of the fifth radiation element 150 may be substantially equal to 0.25 wavelength (λ/4) of the third frequency band FB3 of the antenna structure 100. The length L5 of the sixth radiation element 160 may be from 5 mm to 10 mm. The length L6 of the seventh radiation element 170 may be from 10 mm to 15 mm. The length L7 of the eighth radiation element 180 may be from 8 mm to 12 mm. The length L8 of the ninth radiation element 190 may be from 10 mm to 13 mm. The width of the first coupling gap GC1 may be from 0.5 mm to 1 mm. The width of the second coupling gap GC2 may be from 0.5 mm to 1 mm. The width of the third coupling gap GC3 may be from 0.1 mm to 0.4 mm. The obtuse angle θ may be from 100 to 160 degrees, such as about 140 degrees, about 145 degrees, or about 150 degrees. The above ranges of element sizes are calculated and obtained according to many experimental results, and they help to optimize the operational bandwidth and the impedance matching of the antenna structure 100, and further to minimize the environmental interference factors of the antenna structure 100.

In some embodiments, the aforementioned antenna structure 100 is applied in a POS (Point of Sale) system (not shown). Since the POS system includes the aforementioned antenna structure 100, the POS system can support the function of wireless communication. In some embodiments, the POS system further includes an RF circuit, a filter, an amplifier, a processor, and/or a housing, but it is not limited thereto.

The invention proposes a novel antenna structure. In comparison to the conventional design, the invention has at least the advantages of small size, wide bandwidth, and low environmental interference. Therefore, the invention is suitable for application in a variety of mobile communication devices or the IOT.

Note that the above element sizes, element shapes, and frequency ranges are not limitations of the invention. An antenna designer can fine-tune these settings or values to meet different requirements. It should be understood that the antenna structure of the invention is not limited to the configurations of FIGS. 1 and 2. The invention may merely include any one or more features of any one or more embodiments of FIGS. 1 and 2. In other words, not all of the features displayed in the figures should be implemented in the antenna structure of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antenna structure, comprising:
a first radiation element, having a feeding point;
a second radiation element, coupled to the first radiation element;
a third radiation element, coupled to the first radiation element;
a fourth radiation element, coupled to a ground voltage, wherein the fourth radiation element is adjacent to the first radiation element;
a fifth radiation element, coupled to the ground voltage, wherein the fifth radiation element is adjacent to the first radiation element;
a sixth radiation element, coupled to a first connection point on the third radiation element, wherein the sixth radiation element is adjacent to the fourth radiation element;
a seventh radiation element, coupled to a second connection point on the fourth radiation element;
an eighth radiation element, coupled to a third connection point on the fourth radiation element;
a ninth radiation element, coupled to a fourth connection point on the fourth radiation element; and
a carrier element, wherein the first radiation element, the second radiation element, the third radiation element, the fourth radiation element, the fifth radiation element, the sixth radiation element, the seventh radiation element, the eighth radiation element, and the ninth radiation element are disposed on the carrier element.

2. The antenna structure as claimed in claim 1, wherein the fourth radiation element substantially has a meandering shape.

3. The antenna structure as claimed in claim 1, wherein a combination of the third radiation element and the sixth radiation element substantially has an inverted T-shape.

4. The antenna structure as claimed in claim 1, wherein the seventh radiation element comprises a first portion and a second portion, and an obtuse angle is formed between the first portion and the second portion.

5. The antenna structure as claimed in claim 1, wherein the eighth radiation element comprises a terminal widening portion.

6. The antenna structure as claimed in claim 1, wherein the antenna structure covers a first frequency band, a second frequency band, and a third frequency band, the first frequency band is from 699 MHz to 960 MHz, the second frequency band is from 1710 MHz to 2170 MHz, and the third frequency band is from 2500 MHz to 2690 MHz.

7. The antenna structure as claimed in claim 6, wherein a total length of the first radiation element and the second radiation element is substantially equal to 0.25 wavelength of the first frequency band.

8. The antenna structure as claimed in claim 6, wherein a total length of the first radiation element and the third radiation element is substantially equal to 0.25 wavelength of the second frequency band.

9. The antenna structure as claimed in claim 6, wherein a length of the fourth radiation element is substantially equal to 0.25 wavelength of the first frequency band.

10. The antenna structure as claimed in claim 6, wherein a length of the fifth radiation element is substantially equal to 0.25 wavelength of the third frequency band.
